(19) United States
(12) Patent Application Publication
(10) Pub. No.: US 2024/0105059 A1
(43) Pub. Date: Mar. 28, 2024

(54) DELIMITER-BASED OCCUPANCY MAPPING

(71) Applicants: QUALCOMM Technologies, Inc., San Diego, CA (US); ARRIVER SOFTWARE, LLC, Novi, MI (US)

(72) Inventors: James POPLAWSKI, Canton, MI (US); Avdhut JOSHI, San Marcos, CA (US); Makesh Pravin JOHN WILSON, San Diego, CA (US); Radhika Dilip GOWAIKAR, San Diego, CA (US)

(21) Appl. No.: 18/472,903

(22) Filed: Sep. 22, 2023

Related U.S. Application Data
(60) Provisional application No. 63/410,843, filed on Sep. 28, 2022.

(51) Int. Cl. G08G 1/16; B60W 60/00

(52) U.S. Cl. CPC G08G 1/166; B60W 60/00; G08G 1/161; B60W 2756/10

(57) ABSTRACT

An occupancy map processing method includes: obtaining an occupancy map of a region comprising a plurality of cells, corresponding to sub-regions, each including an occupancy indication indicative of occupier type of the sub-region, and the plurality of cells comprising delimiter cells and non-delimiter cells; and providing, from the apparatus, occupancy information comprising first occupancy information corresponding to the delimiter cells and either second occupancy information corresponding to fewer than all of the non-delimiter cells or no second occupancy information.

### CROSS-REFERENCE TO RELATED APPLICATIONS

This application claims the benefit of U.S. Provisional Application No. 63/410,843, filed Sep. 28, 2022, entitled “DELIMITER-BASED OCCUPANCY MAPPING,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow.

A driver assistance system may mitigate driving risk for a driver of an ego vehicle (i.e., a vehicle configured to perceive the environment of the vehicle) and/or for other road users. Driver assistance systems may include one or more active devices and/or one or more passive devices that can be used to determine the environment of the ego vehicle and, for semi-autonomous vehicles, possibly to notify a driver of a situation that the driver may be able to address. The driver assistance system may be configured to control various aspects of driving safety and/or driver monitoring. For example, a driver assistance system may control a speed of the ego vehicle to maintain at least a desired separation (in distance or time) between the ego vehicle and another vehicle (e.g., as part of an active cruise control system). The driver assistance system may monitor the surroundings of the ego vehicle, e.g., to maintain situational awareness for the ego vehicle. The situational awareness may be used to notify the driver of issues, e.g., another vehicle being in a blind spot of the driver, another vehicle being on a collision path with the ego vehicle, etc. The situational awareness may include information about the ego vehicle (e.g., speed, location, heading) and/or other vehicles or objects (e.g., location, speed, heading, size, object type, etc.).

A state of an ego vehicle may be used as an input to a number of driver assistance functionalities, such as an Advanced Driver assistance system (ADAS). Downstream driving aids such as an ADAS may be safety critical, and/or may give the driver of the vehicle information and/or control the vehicle in some way.

### SUMMARY

An example apparatus includes: a memory; and a processor communicatively coupled to the memory and configured to: obtain an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and provide occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

An example occupancy map processing method includes: obtaining, at an apparatus, an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and providing, from the apparatus, occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

Another example apparatus includes: means for obtaining an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and means for providing occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

An example non-transitory, processor-readable storage medium includes processor-readable instructions to cause a processor to: obtain an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and provide occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is an example of an occupancy information table for the occupancy map shown in FIG. 8.

FIG. 10 is a block diagram of an autonomous driving stack.

FIG. 11 is an example of a delimiter-based occupancy map corresponding to the region shown in FIG. 7.

FIG. 12 is another example of a delimiter-based occupancy map corresponding to the region shown in FIG. 7.

FIG. 13 is another example of a delimiter-based occupancy map corresponding to the region shown in FIG. 7.

FIG. 14 is another example of a delimiter-based occupancy map corresponding to the region shown in FIG. 7.

FIG. 15 is a portion of another example of a delimiter-based occupancy map corresponding to the region shown in FIG. 7.

FIG. 16 is an example of an occupancy information table for an occupancy map a portion of which is shown in FIG. 15.

FIG. 17 is a block flow diagram of an example occupancy map processing method.

### DETAILED DESCRIPTION

Techniques are discussed herein for providing occupancy information for a geographic region. For example, occupancy information indicative of occupiers (if any) of sub-regions of the region may be obtained and analyzed to determine delimiter cells corresponding to the sub-regions along borders between sub-regions with different (non-identical) occupier types (of one or more occupiers). For example, borders between static objects and free space, between mobile objects and free space, between mobile objects and occluded sub-regions, between mobile objects and sub-regions of unknown occupancy, etc. may be determined. Occupancy information corresponding to the borders, e.g., for the delimiter cells, may be provided by an apparatus of a device (such as a vehicle), e.g., internally from one portion of a device to another portion of the device (e.g., within a processor of the device) or externally to an entity outside of the device. Occupancy information for non-delimiter cells may or may not be provided along with the occupancy information for the delimiter cells. Occupancy information for fewer than all non-delimiter cells may be provided along with the occupancy information for the delimiter cells. Compression of an occupancy grid may be achieved using a connected components method. Other configurations, however, may be used.

Items and/or techniques described herein may provide one or more of the following capabilities, as well as other capabilities not mentioned. Amounts of occupancy information for a region that are stored and/or transferred may be reduced compared to occupancy information for the entirety of the region, e.g., saving storage cost and/or saving data transfer bandwidth. The amounts of occupancy information stored and/or transferred may be reduced without losing resolution regarding occupancy of the region. Other capabilities may be provided and not every implementation according to the disclosure must provide any, let alone all, of the capabilities discussed.

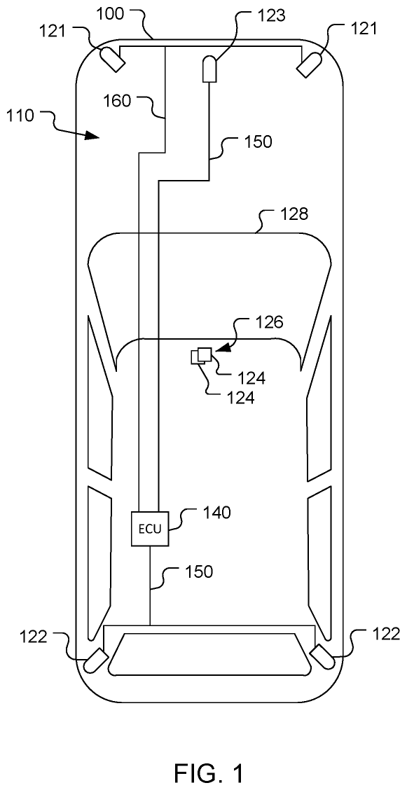

Referring to FIG. 1, an ego vehicle 100 includes an ego vehicle driver assistance system 110. The driver assistance system 110 may include a number of different types of sensors mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100.

Each of the sensors 121 may include an LRR and/or an SRR (Short-Range Radar). The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

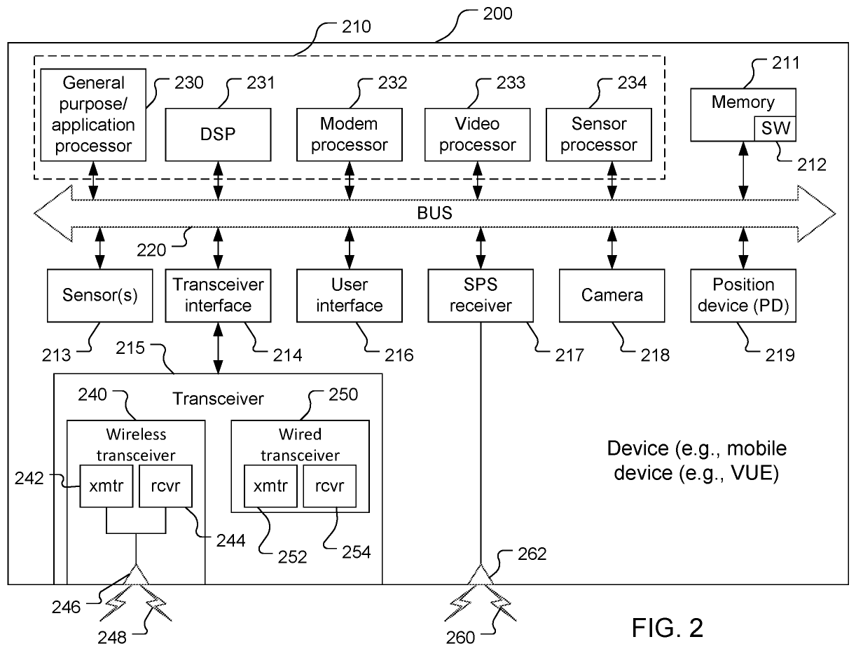

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 is a non-transitory storage medium that may include random access memory (RAM), flash memory, disc memory, and/or read-only memory (ROM), etc. The memory 211 may store the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

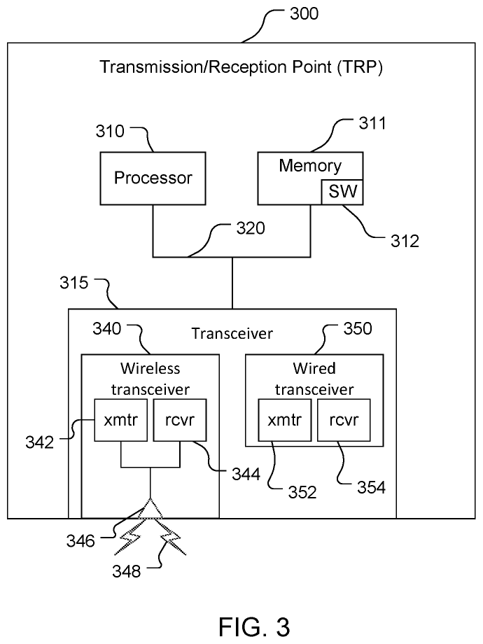

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

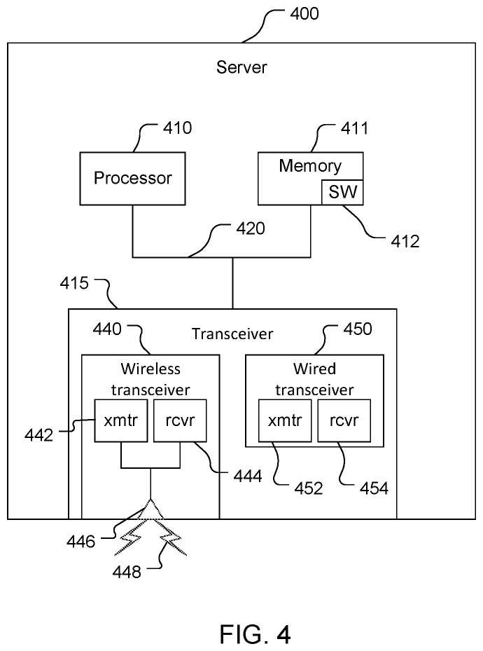

Referring also to FIG. 4, a server 400, of which an LMF is an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

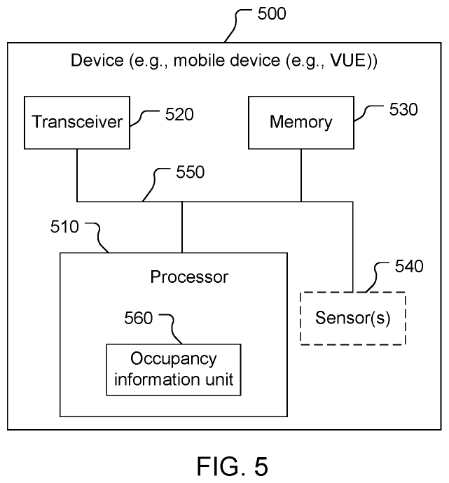

Referring to FIG. 5, a device 500 includes a processor 510, a transceiver 520, a memory 530, and sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy information unit 560 (which may include an ADAS (Advanced Driver Assistance System) for a VUE). The occupancy information unit 560 is discussed further herein, and the description herein may refer to the occupancy information unit 560 performing one or more functions, and/or may refer to the processor 510 generally, or the device 500 generally, as performing any of the functions of the occupancy information unit 560, with the device 500 being configured to perform the functions.

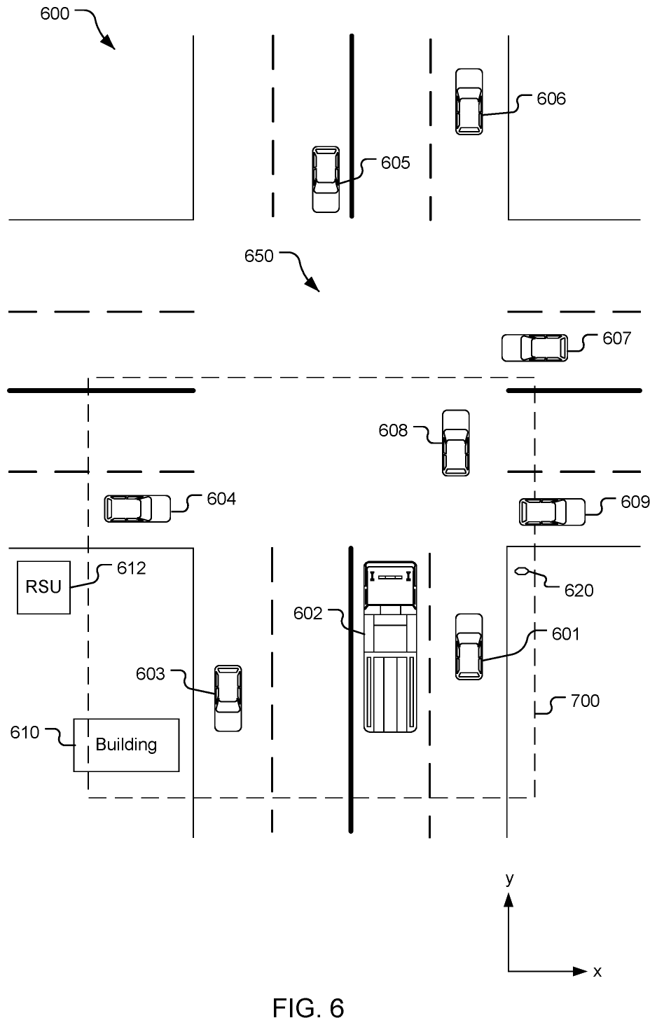

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type (bicycle, car, truck, etc.), etc.).

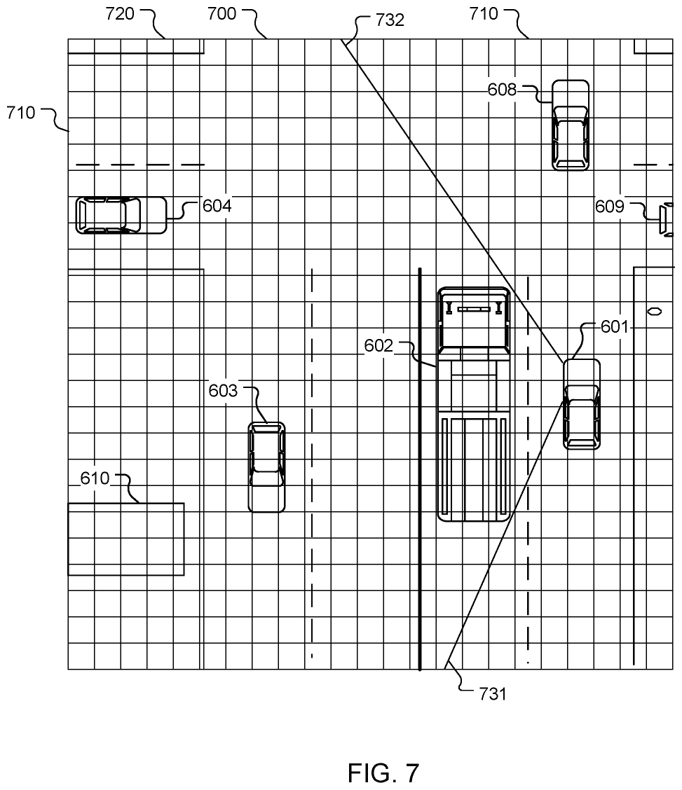

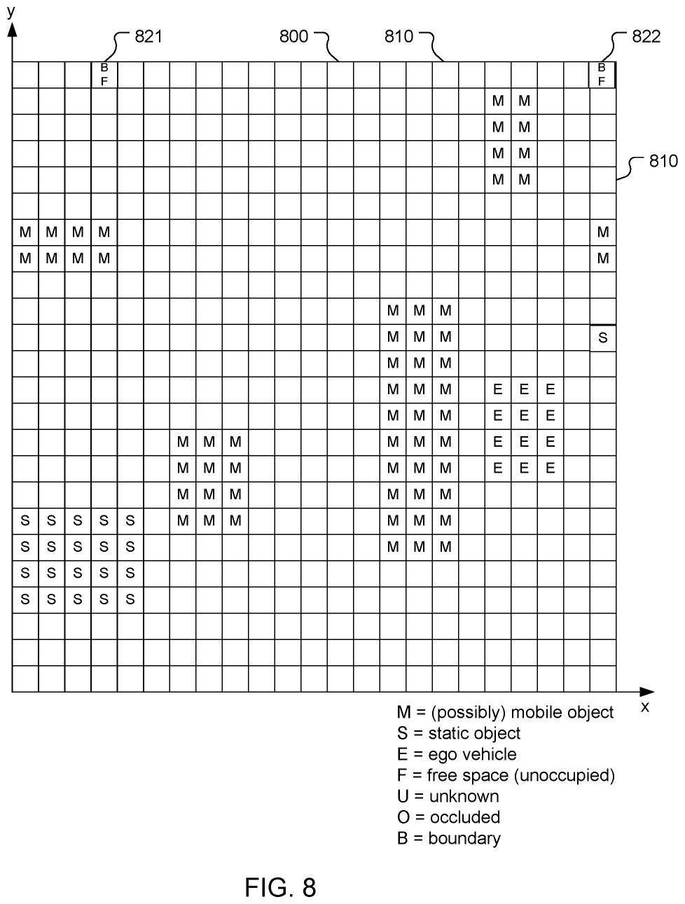

Referring also to FIGS. 7 and 8, a region 700, which in this example spans a portion of the environment 600, may be evaluated to determine an occupancy grid 800 (also called an occupancy map) that indicates an occupier type for each of multiple sub-regions of the region 700. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub-regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8).

Each of the sub-regions 710 may correspond to a respective cell 810 of the occupancy map and information may be obtained regarding what, if anything, occupies each of the sub-regions 710 in order to populate cells 810 of the occupancy map 800 with an occupancy indication indicative of a type of occupier of the sub-region corresponding to the cell. The information as to what, if anything, occupies each of the sub-regions 710 may be obtained from one or more of a variety of sources. For example, occupancy information may be obtained from one or more sensor measurements from one or more of the sensors 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include occupancy information indicating a type of occupier of the sub-region 710 corresponding to the cell 810. As examples, the occupancy information may indicate that the corresponding sub-region 710 is occupied by a static object (S), or may indicate that the corresponding sub-region 710 is occupied by an object that is or may be mobile (M), or may indicate that the corresponding sub-region 710 is occupied by the ego vehicle (E). The occupancy information may indicate free space (F) if no object occupies the corresponding sub-region 710, may indicate unknown (U) if there is no information as to a possible occupier (or available information is inconclusive as to an occupier, if any) of the corresponding sub-region 710, or may indicate that the corresponding sub-region 710 is occluded (O) (including being partially, but not totally, occluded) (e.g., out of line of sight of the ego vehicle). The occupancy information may indicate that the corresponding sub-region 710 is a boundary sub-region, being at a perimeter 720 of the region 700. The occupancy information for a boundary cell (corresponding to a boundary sub-region) may also indicate the occupier type, e.g., B-S for boundary occupied by a static object, B-F for boundary occupied by free space, etc. For example, each of boundary cells 821, 822 indicate that the respective boundary cell 821, 822 is a boundary cell and is occupied by free space. In FIG. 8, only the boundary cells 821, 822 of all of the boundary cells are labeled for sake of clarity of the figure. The occupancy information may indicate occluded instead of unknown if the sub-region 710 was previously in view and is now blocked from view. The occupancy information may indicate multiple occupier types, e.g., mobile occluded if the sub-region 710 was previously determined to be occupied by a mobile object but the sub-region 710 is now occluded. In the example occupancy map 800, the vehicle 601 shown in FIG. 6 is the ego vehicle, and occupancy information for all of the cells 810 has been able to be determined. In the occupancy map 800, the cells 810 that are not labeled (for sake of clarity of the figure) may be free space, unknown, or occluded.

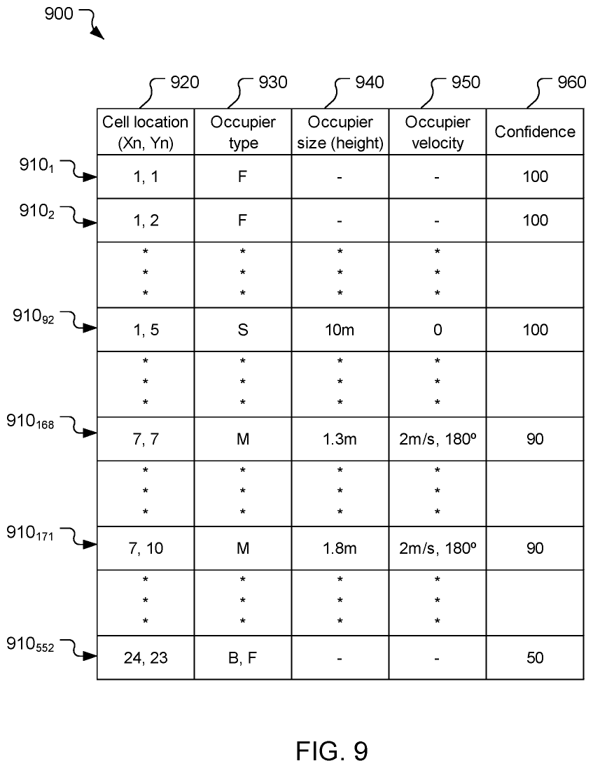

Referring also to FIG. 9, a table 900 of occupancy information, in this example for the occupancy map 800, includes entries 910₁-910₅₅₂ corresponding to the cells 810 of the occupancy map 800, with each entry including occupancy information. In this example, there are 552 entries because there are 24 rows and 23 columns (24×23=552) in the occupancy map 800. Also in this example, the occupancy information includes a cell location field 920, an occupier type field 930, an occupier size field 940, an occupier velocity field 950, and a confidence field 960. The cell location field 920 indicates a cell location as a row number and column number. The cell location field 920 may be omitted from the table 900 if the cell location is implied, e.g., if the number of cells 810 is known and the sequence of the cells 810 in the table 900 is known. The occupier type field 930 indicates one or more of a variety of available occupier types, e.g., free space (F), mobile object (M), static object (S), unknown (U), occluded (O), or ego vehicle (E). The occupier size field 940 may include a height of an occupier in the respective cell 810. The occupier velocity field 950 may indicate a velocity of the occupier of the respective cell 810. The confidence field 960 may, for example, indicate a level of confidence that the occupier type indicated in the occupier type field 930 is correct. As another example, the confidence field 960 may indicate a confidence level that the occupier size and/or the occupier velocity are correct (e.g., the minimum confidence of all of the indicated information being correct). As another example, the confidence field 960 may be represented by a probability value. As another example, the confidence field 960 may include more than one value, e.g., a belief value and a plausibility value as in the Dempster Shafer theory of evidence. As shown, an entry 910₁ is for the first row and the first column of the occupancy map 800 (as indicated in the cell location field 920) that corresponds to a sub-region 710 that is occupied by free space as indicated in the occupier type field 930. Further, an entry 910₂ corresponds to a sub-region 710 occupied by free space, an entry 910₉₂ corresponds to a sub-region 710 occupied by a static object (in this example, the building 610), an entry 910₁₆₈ corresponds to a sub-region 710 occupied by a mobile object (in this example, a front portion of the vehicle 603), an entry 910₁₇₁ corresponds to a sub-region 710 occupied by mobile object (in this example, a rear portion of the vehicle 603), and an entry 910₅₅₂ corresponds to the boundary cell 822 and thus corresponds to a sub-region 710 occupied by free space. The entry 910₉₂ indicates that the height of the building 610 in the indicated cell 810 is 10 m and the velocity of building is 0 m/s. The velocity field 950 may be a null value for static objects. The entries 910₁₆₈, 910₁₇₁ indicate that the height of the vehicle 603 in the respective cells 810 is 1.3 m and 1.8 m, and that the velocity of the vehicle 603 is 2 m/s in a direction of 180° (in the negative-y direction in FIG. 6). As can be seen from the table 900, there is a lot of information used to characterize the occupancy map 800, which may occupy a lot of memory, and will occupy significant communication bandwidth to provide the occupancy information from one apparatus to another, e.g., to transfer the occupancy information between apparatus (e.g., within the processor 510 to perform one or more functions, and/or from the device 500 to another device, e.g., a network entity such as the TRP 300 or the server 400).

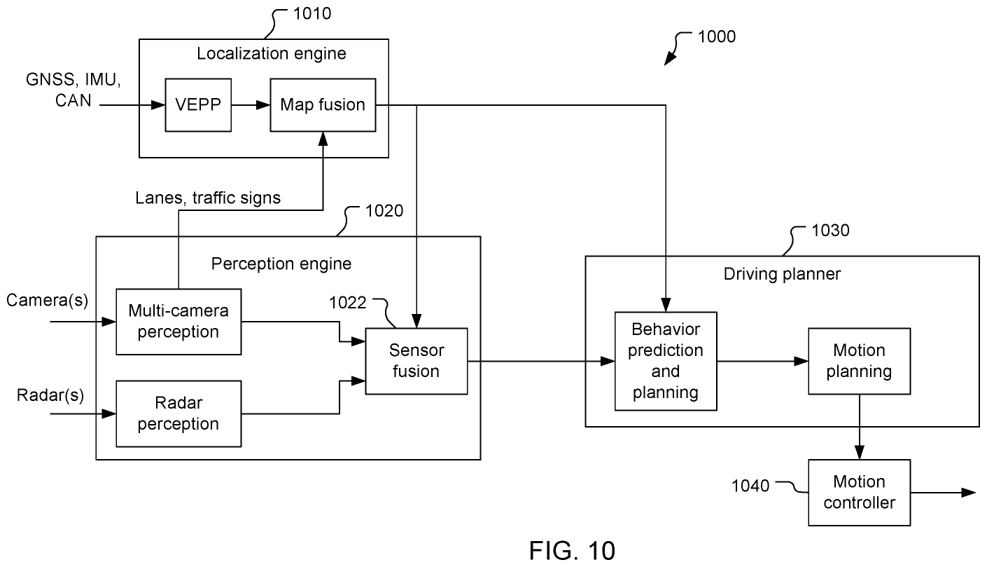

Referring also to FIG. 10, an autonomous driving stack 1000 includes a localization engine 1010, a perception engine 1020, a driving planner 1030, and a motion controller 1040. The autonomous driving stack 1000 may be implemented by the processor 510 (e.g., appropriate hardware and/or firmware, etc.), possibly in combination with the memory 530 (e.g., processor-readable instructions stored on the memory 530). The localization engine 1010 may receive location and/or motion inputs, e.g., GNSS measurements, IMU measurements, and/or CAN (Controller Area Network) measurements, as well as road information (e.g., lanes and traffic signs). The perception engine 1020 may use one or more inputs from one or more of the sensors 540, such as input from one or more cameras and/or from one or more radars, to determine perceived information (e.g., objects, object locations, etc.) and combine such information with information provided by the localization engine 1010 in a sensor fusion unit 1022 to determine the occupancy map 800 (including occupancy information such as an occupancy table). The perception engine 1020 may provide the occupancy information to the driving planner 1030 and/or to one or more entities outside of the device 500. The driving planner 1030 may use the provided occupancy information as well as input from the location engine to predict object behavior and determine planned behavior. The driving planner 1030 may use the predicted and planned behavior to plan motion of the device 500 and provide motion plan information to the motion controller 1040 that may control motion (e.g., braking, acceleration, steering) of the device 500 based on the motion plan information. Because the perception engine 1020 may provide the occupancy information to the driving planner 1030 and/or to one or more entities outside of the device 500, it is desirable to limit the amount of occupancy information, e.g., to conserve storage space and/or communication bandwidth. This is especially true because the perception engine 1020 may provide the occupancy information repeatedly, e.g., at a rate of 20 Hz (and thus every 50 ms).

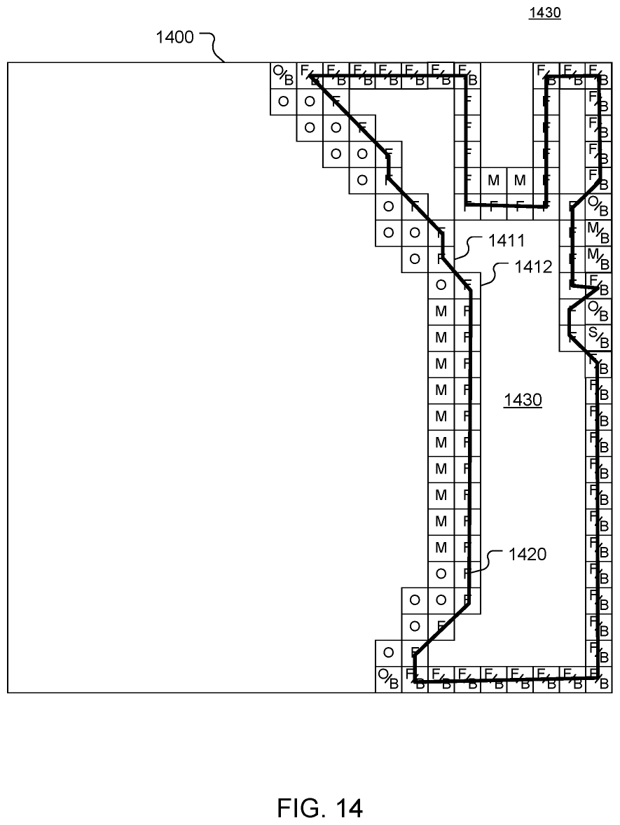

The occupancy information unit 560 may be configured to determine and/or provide a reduced set of occupancy information. For example, the occupancy information unit 560 may be configured to determine components of an occupancy map that are delimiters between different types of occupiers. The components may indicate borders between cells in the occupancy map having different occupier types. The components may be connected components that may be composed of cells classified as free space that form a boundary of an area that contains only the ego vehicle or other free space cells. The components are connected in that the connected components form a continuous boundary in that each cell forming the boundary is adjacent to at least two other cells. Cells may be adjacent to each other if, for example, the cells touch, e.g., share a side (or at least portions of respective sides) or a corner (e.g., cells 1411, 1412 shown in FIG. 14). A cell at a border between different occupier types may be called a delimiter cell, with the delimiter cell having a different occupier type than at least one adjacent cell (e.g., an occluded cell and an adjacent free space cell, or an occluded free space cell and an adjacent free space cell). The occupancy information unit 560 may populate occupancy information (e.g., as shown in FIG. 9) for delimiter cells without populating the occupancy information for non-delimiter cells. An apparatus receiving the delimiter-based occupancy information may infer the occupier types of cells whose occupier types are not specified explicitly in the delimiter-based occupancy information. The occupancy information unit 560 may not populate (or at least not transfer) occupancy information for cells whose occupier type may be inferred, e.g., based on delimiter cell locations and occupier types of the delimiter cells, and possibly knowledge of object size(s). For example, the occupancy information unit 560 may not populate cells within an object, or in regions between delimited borders indicating a change in occupier type.

To populate the occupancy information for an occupancy map, the occupancy information unit 560 may not store the occupancy map. For example, the occupancy map may correspond to which of the cells (e.g., from the occupancy map 800) that the occupancy information unit 560 provides occupancy information for, e.g., from the information unit 560 to another apparatus (e.g., another portion of the processor 510 or to an entity external to the device 500).

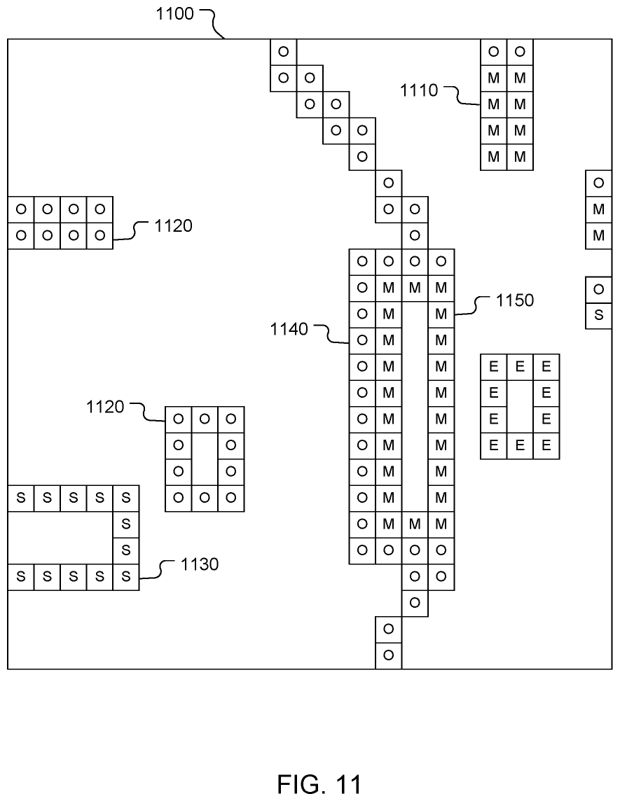

Referring to FIG. 11, with further reference to FIGS. 6-8, a delimiter-based occupancy map 1100 is similar to the occupancy map 800, with cells 1110 that are occluded being indicated. In this example, cells 1120 corresponding to the vehicles 603, 604 are occluded by the vehicle 602 (e.g., a fire engine). While occluded, cells 1130 occupied by the building 610 can be confidently indicated as being occupied by a static object (and may also be indicated to be occluded). Similarly, cells of the vehicle 602 that are occluded may include an occupier type of mobile object if the device 500 knows the size of the vehicle 602, e.g., if the vehicle 602 provides length and width information to the device 500. Occupancy maps, such as the occupancy map 1100, may include occupancy information for less than all of the cells of the map. For example, the occupancy information unit 560 may not populate the cells not explicitly indicated in FIG. 11 as the occupier type of those cells may be inferred, e.g., cells to the left of occluded cells 1140 that are adjacent to, above, and below cells 1150 corresponding to the vehicle 602, because such cells may all be inferred to be occluded (although other occupier type(s) may be indicated for confidently-known cells, e.g., the cells 1130). As another example, indications of boundary cells may be omitted from an occupancy map if the boundary cells may be inferred, e.g., based on a known occupancy map size.

Various implementations are possible for delimiter-based occupancy maps. For example, the occupancy information unit 560 may populate the occupancy information only for delimiter cells, or only for delimiter cells and cells that have at least a threshold confidence (e.g., at least a 90% confidence), e.g., due to the occupancy of the cells being observed by the device 500, or observed by another device that provides occupancy information to the device 500, or the occupancy being confidently derivable by the device 500 (e.g., some cells occupied by an object being observed by the device 500 and the size of the object being known to the device 500). For example, for the occupancy map 1100, the occupancy information unit 560 populated the occupancy information for cells of the vehicles 602, 608, 609 (e.g., if the sizes of the vehicles 602, 606 are known to the device 500), but not the occupancy information for cells of the vehicles 603, 604.

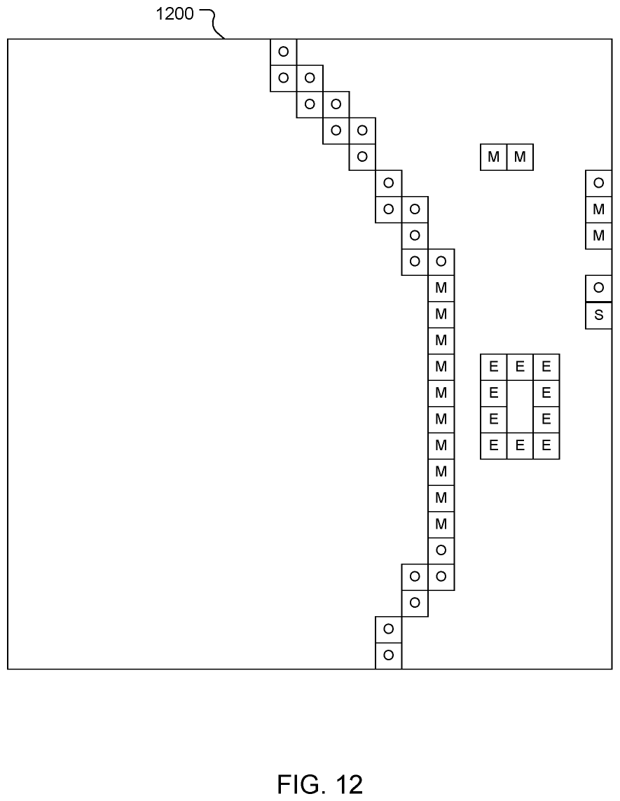

Referring also to FIG. 12, as another example of a delimiter-based occupancy map implementation, the occupancy information unit 560 may populate the occupancy information only for delimiter cells within line of sight of one or more of the sensors 540 of the device 500 (e.g., the vehicle 601). For example, as shown in FIG. 7, sensor line of sight of the vehicle 601 may be bound by the vehicle 602 to borders indicated by lines 731, 732, and may be bound to a rear of the vehicle 608, a rear an partial side of the vehicle 609, and the street sign 620. Consequently, the occupancy information unit 560 may populate occupancy information only for the cells shown in an occupancy map 1200.

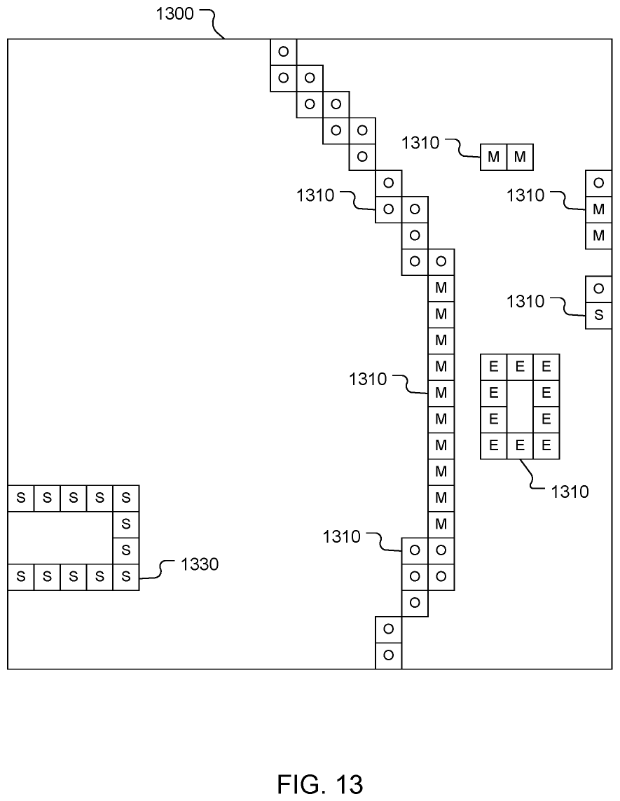

Referring also to FIG. 13, as another example of a delimiter-based occupancy map implementation, the occupancy information unit 560 may populate the occupancy information only for delimiter cells within line of sight of one or more of the sensors 540 of the device 500 and cells that have at least a threshold confidence. For example, as shown in FIG. 13, the occupancy information unit 560 may populate an occupancy map 1300 with the occupancy information for cells 1310 corresponding to the vehicles 601, 602, 608, 609, the street sign 620, and occlusion borders, and for cells 1330 corresponding to the building 610. In this example, the device 500 does not have confidence in the occupier type of the portion of the vehicle 608 that is not visible to the device 500 (here, the vehicle 601).

Referring also to FIG. 14, as another example of a delimiter-based occupancy map implementation, the occupancy information unit 560 may populate an occupancy map, here an occupancy map 1400, with the occupancy information of all delimiter cells, or all delimiter cells within line of sight of the device 500 (as shown in FIG. 14), without populating free-space or ego vehicle cells encompassed by free space connected components. Here, for sake of simplicity, each non-boundary cell has a single occupier type, but cells may have multiple occupier types and a multiple-occupier-type cell may be included in the occupancy map 1400 if at least one adjacent cell has an occupier type that is not identical to the multiple occupier types of the multiple-occupier type cell, whether the adjacent cell has a single occupier type or multiple occupier types.

The occupancy information unit 560 may be configured to output only the free space (including boundary/free space) connected components of an occupancy map as a connected output. For example, the cells lying on a border 1420 comprise a set of connected components. The connected output may be only the connected components in line of sight (LOS) of the ego vehicle, or may include one or more other sets of connected components that are non-line of sight (NLOS) with the ego vehicle but that each have high a confidence value (e.g., above a threshold confidence value). The connected output may exclude ego vehicle and free space cells within a border (encompassed by the connected component cells). Cells adjacent to connected component cells that are outside a border defined by the connected component cells, e.g., outside a region 1430 bounded by the border 1420, will be non-free-space cells (e.g., occluded, unknown, moving object, static object, etc.), except for cells of the connected component cells that lie on a boundary of the occupancy map. For any particular cell in the connected output, information may be provided as to the occupancy type of the cells adjacent to the particular cell, which may help inform any apparatus (e.g., a motion planning unit of the driving planner 1030) receiving the connected output.

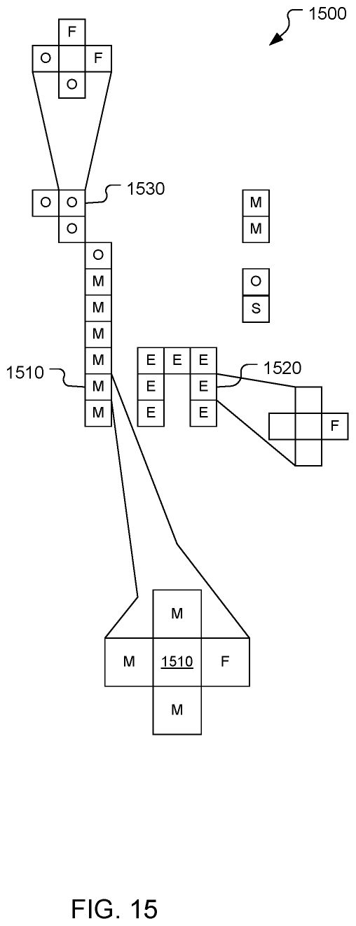

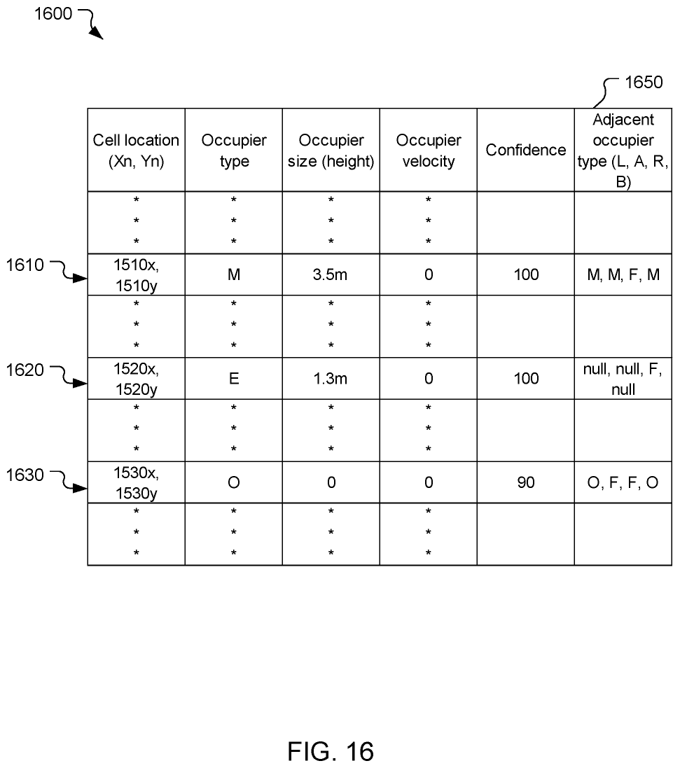

Referring also to FIGS. 15 and 16, as another example of a delimiter-based occupancy map implementation, the occupancy information unit 560 may populate an occupancy map with delimiter cell occupancy information including indications of occupier type(s) of one or more adjacent cells. For example, for each of the occupancy maps 1100, 1200, 1300, 1400, the occupancy information unit 560 may include occupancy information for each populated cell, e.g., with occupancy information similar to the occupancy information shown in, and discussed with respect to, FIG. 9. As another example, instead of populating adjacent delimiter cells with occupancy information, the occupancy information unit 560 may populate a delimiter cell with information about the location and occupier type(s) of one or more adjacent delimiter cells. For example, the occupancy information unit 560 may populate only the cells shown in FIG. 15, with a portion 1500 of the occupancy map 1300 being shown in FIG. 15. For each populated cell, the occupancy information unit 560 may indicate the occupier type of one or more adjacent cells. For example, for a populated cell, the occupancy information unit 560 may indicate the occupier type for every adjacent cell (e.g., to the left, right, above, and below the populated cell, but not diagonal to the populated cell, or including cells diagonal to the populated cell). For example, for populated cells 1510, 1530, entries 1610, 1630 in an occupancy information table 1600 may include indications, in an adjacent occupier type field 1650, of occupier type for each of the four adjacent cells to the left (L), above (A), to the right (R), and below (B) the populated cells 1510, 1530, respectively. The adjacent occupier type field 1650 may thus include indications of the occupier type of each of one or more adjacent cells, and the relative location (location relative to the populated cell) of such one or more adjacent cells. The relative location may not be explicitly indicated by the occupancy information. For example, the relative location may be omitted if the relative location may be inferred (e.g., where all non-populated adjacent cells have the same occupier type). As another example, the occupancy information unit 560 may indicate the occupier type only for adjacent delimiter cells that are not also populated (i.e., for which occupancy information is provided in the occupancy map). For example, for a populated cell 1520, an entry 1620 in the table 1600 may indicate in the adjacent occupier type field 1650 the occupier type (F) of the cell to the right of the populated cell 1520 but not indicate the occupier types of the cells to the left, above, or below the populated cell 1520 because those cells are populated and thus will have respective entries in the table 1600 with respective occupancy information. In this way, the occupancy map may include occupancy information in fewer than all delimiter cells, and may save memory and/or bandwidth to store and/or transfer the occupancy information of the occupancy map.

Providing occupancy information according to any of the occupancy maps 1100, 1200, 1300, 1400 may reduce the information provided relative to the occupancy map 800. By providing occupancy information for delimiter cells without providing occupancy information for at least some non-delimiter cells can reduce the memory and/or bandwidth used to store and/or transfer occupancy information. The resolution of the occupancy map 800 may not be lost even though the amount of information transferred may be reduced, e.g., because the occupancy information of the occupancy map 800 may be reproduced from the delimiter-based occupancy information provided.

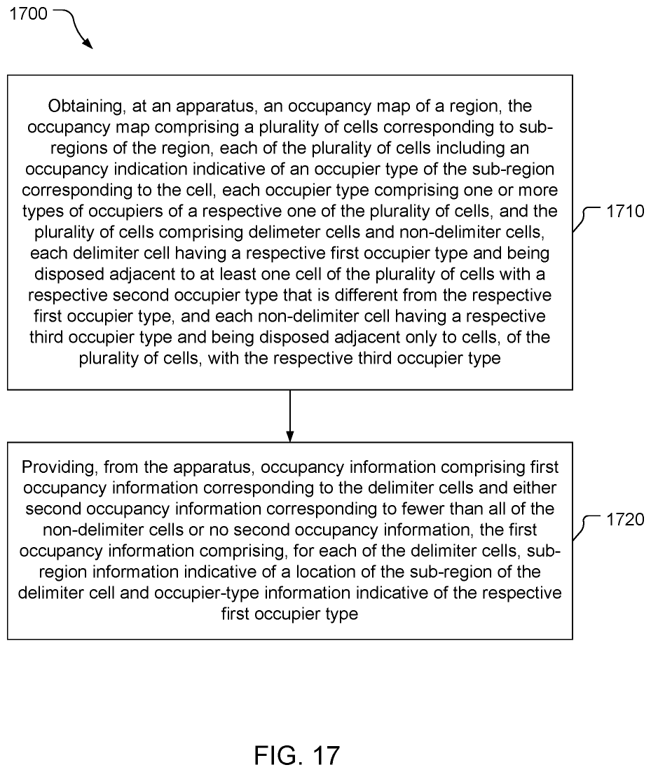

Referring to FIG. 17, with further reference to FIGS. 1-16, an occupancy map processing method 1700 includes the stages shown. The method 1700 is, however, an example and not limiting. The method 1700 may be altered, e.g., by having one or more stages added, removed, rearranged, combined, performed concurrently, and/or having one or more stages split into multiple stages.

At stage 1710, the method 1700 includes obtaining, at an apparatus, an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type. For example, the occupancy information unit 560 may collect occupancy information by processing sensor measurements from the sensor(s) 540 (e.g., camera images, GNSS measurements, radar measurements, lidar (light detection and ranging) measurements, etc.) and/or may receive occupancy information from one or more entities outside of the device 500 (e.g., the RSU 612, one or more of the vehicles 602-609, etc.). The occupancy information includes information about the occupier(s) of cells of a geographic region, e.g., the sub-regions 710 corresponding to the region 700. The cells include delimiter cells disposed along borders of cell occupier type disparities where the occupier types of adjacent cells are non-identical, i.e., a set of one or more occupiers of one cell is different from the set of one or more occupiers of an adjacent cell. The delimiter cells may be identified, e.g., by the occupancy information unit 560. The occupancy map may be stored (e.g., buffered) for analysis, e.g., to determine what occupancy information to provide (e.g., occupancy information for which cells). The processor 510, possibly in combination with the memory 530, possibly in combination with the transceiver 520 (e.g., a wireless receiver and an antenna such as the wireless receiver 244 and the antenna 246), and/or possibly in combination with the sensor(s) 540 (e.g., one or more cameras, one or more radars, the SPS receiver 217, etc.), may comprise means for obtaining the occupancy map.

At stage 1720, the method 1700 includes providing, from the apparatus, occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type. For example, the occupancy information unit 560 (e.g., the perception engine 1020) may provide occupancy information (e.g., as discussed with respect to FIGS. 9 and/or 16) for delimiter cells and possibly for some, but not all, non-delimiter cells. This may save memory and/or bandwidth for storing and/or providing the occupancy information, e.g., to be analyzed by one or more other apparatus (e.g., the driving planner, another apparatus in the device 500, and/or one or more apparatus external to the device 500) to determine desired information, e.g., motion control (e.g., for collision avoidance, traffic flow, etc.). Processing time may also be saved to transfer and/or analyze the occupancy information, thus transferring the occupancy information in less time and/or making decisions based on the occupancy information sooner than if occupancy information for all cells in an occupancy map is transferred. The processor 510, possibly in combination with the memory 530, possibly in combination with the transceiver 520 (e.g., a wireless transmitter and an antenna such as the wireless transmitter 242 and the antenna 246) may comprise means for providing the occupancy information.

Implementations of the method 1700 may include one or more of the following features. In an example implementation, providing the occupancy information comprises providing only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle. For example, the occupancy information unit 560 may provide occupancy information only for the cells disposed along the border 1420. This may dramatically reduce the amount of information transferred (e.g., internally to the device 500 and/or outside of the device 500), possibly while retaining the resolution provided by the entire occupancy map 1400. In another example implementation, the method 1700 includes providing, as part of the occupancy information for each of the delimiter cells, at least the respective second occupier type of at least one cell, of the plurality of cells, disposed adjacent to the respective delimiter cell. For example, the occupancy information unit 560 may provide occupancy information for a delimiter cell and one or more indications of the occupier type of an adjacent cell that has a different occupier type than the delimiter cell, e.g., as shown in the table 1600. The processor 510, possibly in combination with the memory 530, possibly in combination with the transceiver 520 (e.g., a wireless transmitter and an antenna such as the wireless transmitter 242 and the antenna 246) may comprise means for providing at least the respective second occupier type. In a further example implementation, the method 1700 includes providing, as part of the occupancy information for each of the delimiter cells, an indication of location, relative to the respective delimiter cell, of each of the at least one cell disposed adjacent to the respective delimiter cell. For example, the occupancy information unit 560 may explicitly or implicitly (e.g., as in the table 1600) provide the location, relative to the delimiter cell, of the adjacent cell for which the occupier type is provided. The processor 510, possibly in combination with the memory 530, possibly in combination with the transceiver 520 (e.g., a wireless transmitter and an antenna such as the wireless transmitter 242 and the antenna 246) may comprise means for providing the indication of location.

Also or alternatively, implementations of the method 1700 may include one or more of the following features. In an example implementation, providing the occupancy information comprises providing only the first occupancy information. For example, the occupancy information unit 560 may provide occupancy information only for delimiter cells e.g., as in the occupancy map 1300 (for only line-of-sight delimiter cells), or as in the occupancy map 1100 (for delimiter cells with at least a threshold level of confidence). This may help conserve memory and/or transmission bandwidth, saving expense and/or saving processing time to transfer the information and/or to analyze the occupancy information (e.g., for driving prediction and/or planning and/or other desired use). Thus, quicker decisions may be made based on the occupancy information than if occupancy information for all cells or more than just delimiter cells is transferred. In another example implementation, the method 1700 includes providing, from the apparatus, third occupancy information for respective boundary cells, of the non-delimiter cells, disposed along a perimeter of the region, the third occupancy information being indicative of locations and occupier types of the boundary cells. For example, the occupancy information unit 560 may provide occupancy information for boundary cells even if occupancy information for such cells would otherwise not be provided. The processor 510, possibly in combination with the memory 530, possibly in combination with the transceiver 520 (e.g., a wireless transmitter and an antenna such as the wireless transmitter 242 and the antenna 246) may comprise means for providing the third occupancy information. In another example implementation, providing the occupancy information comprises providing the occupancy information from a first portion of an autonomous driving stack of a vehicle to a second portion of the autonomous driving stack of the vehicle. For example, the processor 510 may transfer occupancy information internally to the device 500, e.g., the perception engine 1020 may provide the occupancy information to the driving planner 1030. In another example implementation, providing the occupancy information comprises providing the occupancy information wirelessly from a vehicle to a network entity. For example, the occupancy information unit 560 may provide the occupancy information via the transceiver 520 to a network entity such as the TRP 300 (e.g., the RSU 612), a server (e.g., via the TRP 300). In another example implementation, providing the occupancy information comprises providing the first occupancy information for fewer than all of the delimiter cells of the occupancy map. For example, occupancy information for one of adjacent delimiter cells may be provided. The occupancy information may include an indication of occupier type and location of one or more adjacent delimiter cells, e.g., as shown in the table 1600. This may save storage and/or transfer bandwidth, e.g., by transferring more data in a delimiter cell occupancy information table entry (e.g., the entry 1610 compared to the entry 910₁₆₈) but transferring fewer occupancy table entries.

### Implementation Examples

Implementation examples are provided in the following numbered clauses.

Clause 1. An apparatus comprising:
a memory; and
a processor communicatively coupled to the memory and configured to:
   obtain an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and
   provide occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

Clause 2. The apparatus of clause 1, wherein to provide the occupancy information the processor is configured to provide only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle.

Clause 3. The apparatus of clause 1, wherein the processor is configured to provide, as part of the occupancy information for each of the delimiter cells, at least the respective second occupier type of at least one cell, of the plurality of cells, disposed adjacent to the respective delimiter cell.

Clause 4. The apparatus of clause 3, wherein the processor is configured to provide, as part of the occupancy information for each of the delimiter cells, an indication of location, relative to the respective delimiter cell, of each of the at least one cell disposed adjacent to the respective delimiter cell.

Clause 5. The apparatus of clause 1, wherein of the first occupancy information and the second occupancy information, the processor is configured to provide only the first occupancy information.

Clause 6. The apparatus of clause 1, wherein the processor is further configured to provide third occupancy information for respective boundary cells, of the non-delimiter cells, disposed along a perimeter of the region, the third occupancy information being indicative of locations and occupier types of the boundary cells.

Clause 7. The apparatus of clause 1, wherein the processor is configured to provide the occupancy information from a first portion of an autonomous driving stack of a vehicle to a second portion of the autonomous driving stack of the vehicle.

Clause 8. The apparatus of clause 1, further comprising a transmitter configured to transmit wireless signals, wherein the processor is configured provide the occupancy information wirelessly via the transmitter to a network entity.

Clause 9. The apparatus of clause 1, wherein the processor is configured to provide the first occupancy information for fewer than all of the delimiter cells of the occupancy map.

Clause 10. An occupancy map processing method comprising:
obtaining, at an apparatus, an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and
providing, from the apparatus, occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

Clause 11. The occupancy map processing method of clause 10, wherein providing the occupancy information comprises providing only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle.

Clause 12. The occupancy map processing method of clause 10, further comprising providing, as part of the occupancy information for each of the delimiter cells, at least the respective second occupier type of at least one cell, of the plurality of cells, disposed adjacent to the respective delimiter cell.

Clause 13. The occupancy map processing method of clause 12, further comprising providing, as part of the occupancy information for each of the delimiter cells, an indication of location, relative to the respective delimiter cell, of each of the at least one cell disposed adjacent to the respective delimiter cell.

Clause 14. The occupancy map processing method of clause 10, wherein providing the occupancy information comprises providing only the first occupancy information.

Clause 15. The occupancy map processing method of clause 10, further comprising providing, from the apparatus, third occupancy information for respective boundary cells, of the non-delimiter cells, disposed along a perimeter of the region, the third occupancy information being indicative of locations and occupier types of the boundary cells.

Clause 16. The occupancy map processing method of clause 10, wherein providing the occupancy information comprises providing the occupancy information from a first portion of an autonomous driving stack of a vehicle to a second portion of the autonomous driving stack of the vehicle.

Clause 17. The occupancy map processing method of clause 10, wherein providing the occupancy information comprises transmitting the occupancy information wirelessly from a vehicle to a network entity.

Clause 18. The occupancy map processing method of clause 10, wherein providing the occupancy information comprises providing the first occupancy information for fewer than all of the delimiter cells of the occupancy map.

Clause 19. An apparatus comprising:
means for obtaining an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and
means for providing occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

Clause 20. The apparatus of clause 19, wherein the means for providing the occupancy information comprise means for providing only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle.

Clause 21. The apparatus of clause 19, further comprising means for providing, as part of the occupancy information for each of the delimiter cells, at least the respective second occupier type of at least one cell, of the plurality of cells, disposed adjacent to the respective delimiter cell.

Clause 22. The apparatus of clause 21, further comprising means for providing, as part of the occupancy information for each of the delimiter cells, an indication of location, relative to the respective delimiter cell, of each of the at least one cell disposed adjacent to the respective delimiter cell.

Clause 23. The apparatus of clause 19, wherein the means for providing the occupancy information comprise means for providing only the first occupancy information.

Clause 24. The apparatus of clause 19, further comprising means for providing third occupancy information for respective boundary cells, of the non-delimiter cells, disposed along a perimeter of the region, the third occupancy information being indicative of locations and occupier types of the boundary cells.

Clause 25. The apparatus of clause 19, wherein the means for providing the occupancy information comprise means for providing the occupancy information from a first portion of an autonomous driving stack of a vehicle to a second portion of the autonomous driving stack of the vehicle.

Clause 26. The apparatus of clause 19, wherein the means for providing the occupancy information comprise means for transmitting the occupancy information wirelessly from a vehicle to a network entity.

Clause 27. The apparatus of clause 19, wherein the means for providing the occupancy information comprise means for providing the first occupancy information for fewer than all of the delimiter cells of the occupancy map.

Clause 28. A non-transitory, processor-readable storage medium comprising processor-readable instructions to cause a processor to:
obtain an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and
provide occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

Clause 29. The non-transitory, processor-readable storage medium of clause 28, wherein the processor-readable instructions to cause the processor to provide the occupancy information comprise processor-readable instructions to cause the processor to provide only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle.

Clause 30. The non-transitory, processor-readable storage medium of clause 28, further comprising processor-readable instructions to cause the processor to provide, as part of the occupancy information for each of the delimiter cells, at least the respective second occupier type of at least one cell, of the plurality of cells, disposed adjacent to the respective delimiter cell.

Clause 31. The non-transitory, processor-readable storage medium of clause 30, further comprising processor-readable instructions to cause the processor to provide, as part of the occupancy information for each of the delimiter cells, an indication of location, relative to the respective delimiter cell, of each of the at least one cell disposed adjacent to the respective delimiter cell.

Clause 32. The non-transitory, processor-readable storage medium of clause 28, wherein the processor-readable instructions to cause the processor to provide the occupancy information comprise processor-readable instructions to cause the processor to provide only the first occupancy information.

Clause 33. The non-transitory, processor-readable storage medium of clause 28, further comprising processor-readable instructions to cause the processor to provide third occupancy information for respective boundary cells, of the non-delimiter cells, disposed along a perimeter of the region, the third occupancy information being indicative of locations and occupier types of the boundary cells.

Clause 34. The non-transitory, processor-readable storage medium of clause 28, wherein the processor-readable instructions to cause the processor to provide the occupancy information comprise processor-readable instructions to cause the processor to provide the occupancy information from a first portion of an autonomous driving stack of a vehicle to a second portion of the autonomous driving stack of the vehicle.

Clause 35. The non-transitory, processor-readable storage medium of clause 28, wherein the processor-readable instructions to cause the processor to provide the occupancy information comprise processor-readable instructions to cause the processor to transmit the occupancy information wirelessly from a vehicle to a network entity.

Clause 36. The non-transitory, processor-readable storage medium of clause 28, wherein the processor-readable instructions to cause the processor to provide the occupancy information comprise processor-readable instructions to cause the processor to provide the first occupancy information for fewer than all of the delimiter cells of the occupancy map.

Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
a memory; and
a processor communicatively coupled to the memory and configured to:
obtain an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and
provide occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

2. The apparatus of claim 1, wherein to provide the occupancy information the processor is configured to provide only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle.

3. The apparatus of claim 1, wherein the processor is configured to provide, as part of the occupancy information for each of the delimiter cells, at least the respective second occupier type of at least one cell, of the plurality of cells, disposed adjacent to the respective delimiter cell.

4. The apparatus of claim 3, wherein the processor is configured to provide, as part of the occupancy information for each of the delimiter cells, an indication of location, relative to the respective delimiter cell, of each of the at least one cell disposed adjacent to the respective delimiter cell.

5. The apparatus of claim 1, wherein of the first occupancy information and the second occupancy information, the processor is configured to provide only the first occupancy information.

6. The apparatus of claim 1, wherein the processor is further configured to provide third occupancy information for respective boundary cells, of the non-delimiter cells, disposed along a perimeter of the region, the third occupancy information being indicative of locations and occupier types of the boundary cells.

7. The apparatus of claim 1, wherein the processor is configured to provide the occupancy information from a first portion of an autonomous driving stack of a vehicle to a second portion of the autonomous driving stack of the vehicle.

8. The apparatus of claim 1, further comprising a transmitter configured to transmit wireless signals, wherein the processor is configured provide the occupancy information wirelessly via the transmitter to a network entity.

9. The apparatus of claim 1, wherein the processor is configured to provide the first occupancy information for fewer than all of the delimiter cells of the occupancy map.

10. An occupancy map processing method comprising:
obtaining, at an apparatus, an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and
providing, from the apparatus, occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

11. The occupancy map processing method of claim 10, wherein providing the occupancy information comprises providing only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle.

12. The occupancy map processing method of claim 10, further comprising providing, as part of the occupancy information for each of the delimiter cells, at least the respective second occupier type of at least one cell, of the plurality of cells, disposed adjacent to the respective delimiter cell.

13. The occupancy map processing method of claim 12, further comprising providing, as part of the occupancy information for each of the delimiter cells, an indication of location, relative to the respective delimiter cell, of each of the at least one cell disposed adjacent to the respective delimiter cell.

14. The occupancy map processing method of claim 10, wherein providing the occupancy information comprises providing only the first occupancy information.

15. The occupancy map processing method of claim 10, further comprising providing, from the apparatus, third occupancy information for respective boundary cells, of the non-delimiter cells, disposed along a perimeter of the region, the third occupancy information being indicative of locations and occupier types of the boundary cells.

16. The occupancy map processing method of claim 10, wherein providing the occupancy information comprises providing the occupancy information from a first portion of an autonomous driving stack of a vehicle to a second portion of the autonomous driving stack of the vehicle.

17. The occupancy map processing method of claim 10, wherein providing the occupancy information comprises transmitting the occupancy information wirelessly from a vehicle to a network entity.

18. The occupancy map processing method of claim 10, wherein providing the occupancy information comprises providing the first occupancy information for fewer than all of the delimiter cells of the occupancy map.

19. An apparatus comprising:
means for obtaining an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and
means for providing occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

20. The apparatus of claim 19, wherein the means for providing the occupancy information comprise means for providing only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle.

21. The apparatus of claim 19, further comprising means for providing, as part of the occupancy information for each of the delimiter cells, at least the respective second occupier type of at least one cell, of the plurality of cells, disposed adjacent to the respective delimiter cell.

22. The apparatus of claim 21, further comprising means for providing, as part of the occupancy information for each of the delimiter cells, an indication of location, relative to the respective delimiter cell, of each of the at least one cell disposed adjacent to the respective delimiter cell.

23. The apparatus of claim 19, wherein the means for providing the occupancy information comprise means for providing only the first occupancy information.

24. The apparatus of claim 19, further comprising means for providing third occupancy information for respective boundary cells, of the non-delimiter cells, disposed along a perimeter of the region, the third occupancy information being indicative of locations and occupier types of the boundary cells.

25. The apparatus of claim 19, wherein the means for providing the occupancy information comprise means for providing the occupancy information from a first portion of an autonomous driving stack of a vehicle to a second portion of the autonomous driving stack of the vehicle.

26. The apparatus of claim 19, wherein the means for providing the occupancy information comprise means for transmitting the occupancy information wirelessly from a vehicle to a network entity.

27. The apparatus of claim 19, wherein the means for providing the occupancy information comprise means for providing the first occupancy information for fewer than all of the delimiter cells of the occupancy map.

28. A non-transitory, processor-readable storage medium comprising processor-readable instructions to cause a processor to:
obtain an occupancy map of a region, the occupancy map comprising a plurality of cells corresponding to sub-regions of the region, each of the plurality of cells including an occupancy indication indicative of an occupier type of the sub-region corresponding to the cell, each occupier type comprising one or more types of occupiers of a respective one of the plurality of cells, and the plurality of cells comprising delimiter cells and non-delimiter cells, each delimiter cell having a respective first occupier type and being disposed adjacent to at least one cell of the plurality of cells with a respective second occupier type that is different from the respective first occupier type, and each non-delimiter cell having a respective third occupier type and being disposed adjacent only to cells, of the plurality of cells, with the respective third occupier type; and
provide occupancy information comprising first occupancy information corresponding to the delimiter cells and either second occupancy information corresponding to fewer than all of the non-delimiter cells or no second occupancy information, the first occupancy information comprising, for each of the delimiter cells, sub-region information indicative of a location of the sub-region of the delimiter cell and occupier-type information indicative of the respective first occupier type.

29. The non-transitory, processor-readable storage medium of claim 28, wherein the processor-readable instructions to cause the processor to provide the occupancy information comprise processor-readable instructions to cause the processor to provide only a portion of the first occupancy information that corresponds to one or more connected component sets of the delimiter cells, wherein the delimiter cells in each of the one or more connected component sets of the delimiter cells has an occupancy type of free space, or boundary and free space, and is adjacent to at least two other delimiter cells in the respective connected component set of delimiter cells, each of the one or more connected component sets of the delimiter cells encompassing an area containing only cells, of the plurality of cells, having respective occupier types of free space or ego vehicle.

30. The non-transitory, processor-readable storage medium of claim 28, further comprising processor-readable instructions to cause the processor to provide, as part of the occupancy information for each of the delimiter cells, at least the respective second occupier type of at least one cell, of the plurality of cells, disposed adjacent to the respective delimiter cell.
